(19) United States
(12) Patent Application Publication
(10) Pub. No.: US 2022/0255724 A1
(43) Pub. Date: Aug. 11, 2022

(54) METHOD AND APPARATUS FOR DETERMINING ENCRYPTION MASK, DEVICE AND STORAGE MEDIUM

(71) Applicant: Beijing Baidu Netcom Science Technology Co., Ltd., Beijing (CN)

(72) Inventors: Ji LIU, Beijing (CN); Qilong LI, Beijing (CN); Dejing DOU, Beijing (CN); Chongsheng ZHANG, Beijing (CN)

(21) Appl. No.: 17/730,988

(22) Filed: Apr. 27, 2022

(30) Foreign Application Priority Data
Sep. 17, 2021 (CN) 202111094438.7

(51) Int. Cl. H04L 9/06; G06V 10/774; G06V 10/10

(52) U.S. Cl. CPC H04L 9/06; G06V 10/82; G06V 10/16; G06V 10/774

(57) ABSTRACT

The present disclosure provides a method and apparatus for determining an encryption mask, a method and apparatus for recognizing an image, a method and apparatus for training a model, a device, a storage medium and a computer program product. A specific implementation comprises: acquiring a test image set and an encryption mask set; superimposing an image in the test image set with a mask in the encryption mask set to obtain an encrypted image set; recognizing an image in the encrypted image set using a pre-trained encrypted image recognition model and recognizing the image in the encrypted image set using a pre-trained original image recognition model to obtain a first recognition result; and determining a target encryption mask from the encryption mask set based on the first recognition result.

### CROSS-REFERENCE TO RELATED APPLICATION

The present application claims the priority of Chinese Patent Application No. 202111094438.7, titled “METHOD AND APPARATUS FOR DETERMINING ENCRYPTION MASK, DEVICE AND STORAGE MEDIUM”, filed on Sep. 17, 2021, the content of which is incorporated herein by reference in its entirety.

### TECHNICAL FIELD

The present disclosure relates to the field of artificial intelligence technology, and specifically to the fields of computer vision and deep learning technologies, can be applied to scenarios such as an image processing scenario and an image recognition scenario. The present disclosure particularly relates to a method and apparatus for determining an encryption mask, a method and apparatus for recognizing an image, a method and apparatus for training a model, a device, a storage medium and a computer program product.

### BACKGROUND

At present, in image recognition, entire images are usually recognized directly, which makes it easy to leak the private information in the images.

### SUMMARY

The present disclosure provides a method for determining an encryption mask, a device, and a storage medium.

According to an aspect of the present disclosure, a method for determining an encryption mask is provided, and the method includes: acquiring a test image set and an encryption mask set; superimposing an image in the test image set with a mask in the encryption mask set to obtain an encrypted image set; recognizing an image in the encrypted image set using a pre-trained encrypted image recognition model and recognizing the image in the encrypted image set using a pre-trained original image recognition model to obtain a first recognition result; and determining a target encryption mask from the encryption mask set based on the first recognition result.

According to another aspect of the present disclosure, an electronic device is provided, and the device includes: at least one processor; and a storage device, communicated with the at least one processor, where the storage device stores instructions executable by the at least one processor, and the instructions, when executed by the at least one processor, cause the at least one processor to perform the method for determining an encryption mask.

According to yet another aspect of the present disclosure, a non-transitory computer readable storage medium, storing computer instructions is provided, where the computer instructions cause a computer to perform the method for determining an encryption mask.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a diagram of an exemplary system architecture in which the present disclosure may be applied;

FIG. 2 is a flowchart of an embodiment of a method for determining an encryption mask according to the present disclosure;

FIG. 3 is a flowchart of another embodiment of the method for determining an encryption mask according to the present disclosure;

FIG. 4 is a flowchart of another embodiment of the method for determining an encryption mask according to the present disclosure;

FIG. 5 is a flowchart of another embodiment of the method for determining an encryption mask according to the present disclosure;

FIG. 6 is a flowchart of an embodiment in which a target encryption mask is determined from a target encryption mask subset, according to the present disclosure;

FIG. 7 is a flowchart of an embodiment in which a target encryption mask is determined from a candidate encryption mask set based on a pre-trained encrypted image recognition model and a pre-trained image restoration model, according to the present disclosure;

FIG. 8 is a flowchart of an embodiment of a method for recognizing an image according to the present disclosure;

FIG. 9 is a flowchart of an embodiment of a method for training a model according to the present disclosure;

FIG. 10 is a schematic structural diagram of an embodiment of an apparatus for determining an encryption mask according to the present disclosure;

FIG. 11 is a schematic structural diagram of an embodiment of an apparatus for recognizing an image according to the present disclosure;

FIG. 12 is a schematic structural diagram of an embodiment of an apparatus for training a model according to the present disclosure; and

FIG. 13 is a block diagram of an electronic device used to implement the method for determining an encryption mask, the method for recognizing an image or the method for training a model according to embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

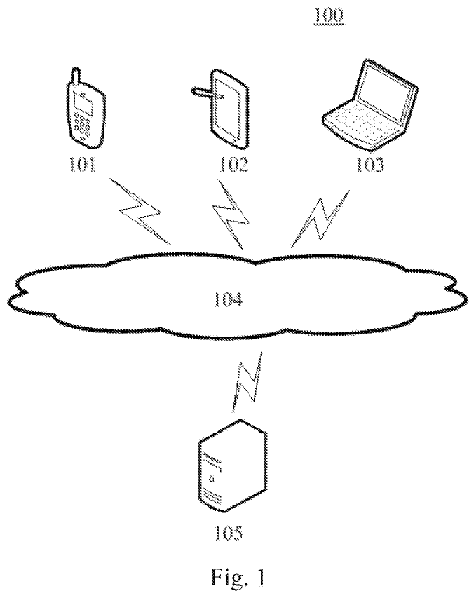

FIG. 1 illustrates an exemplary system architecture 100 in which an embodiment of a method for determining an encryption mask, a method for recognizing an image, a method for training a model, an apparatus for determining an encryption mask, an apparatus for recognizing an image, or an apparatus for training a model according to the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, for example, wired or wireless communication links, or optical fiber cables.

A user may use the terminal devices 101, 102 and 103 to interact with the server 105 via the network 104, to acquire a target encryption mask, etc. Various client applications (e.g., an image processing application) may be installed on the terminal devices 101, 102 and 103.

The terminal devices 101, 102 and 103 may be hardware or software. When being the hardware, the terminal devices 101, 102 and 103 may be various electronic devices, the electronic devices including, but not limited to, a smartphone, a tablet computer, a laptop portable computer, a desktop computer, and the like. When being the software, the terminal devices 101, 102 and 103 may be installed in the above listed electronic devices. The terminal devices 101, 102 and 103 may be implemented as a plurality of pieces of software or a plurality of software modules, or may be implemented as a single piece of software or a single software module, which will not be specifically limited here.

The server 105 may provide various services based on the determination for an encryption mask. For example, the server 105 may analyze and process a test image set and encryption mask set acquired from the terminal devices 101, 102 and 103, and generate a processing result (e.g., determine a target encryption mask, etc.).

It should be noted that the server 105 may be hardware or software. When being the hardware, the server 105 may be implemented as a distributed server cluster composed of a plurality of servers, or may be implemented as a single server. When being the software, the server 105 may be implemented as a plurality of pieces of software or a plurality of software modules (e.g., software or software modules for providing a distributed service), or may be implemented as a single piece of software or a single software module, which will not be specifically limited here.

It should be noted that the method for determining an encryption mask, the method for recognizing an image or the method for training a model provided in the embodiments of the present disclosure is generally performed by the server 105. Correspondingly, the apparatus for determining an encryption mask, the apparatus for recognizing an image or the apparatus for training a model is generally provided in the server 105.

It should be appreciated that the numbers of the terminal devices, the network and the server in FIG. 1 are merely illustrative. Any number of terminal devices, networks and servers may be provided based on actual requirements.

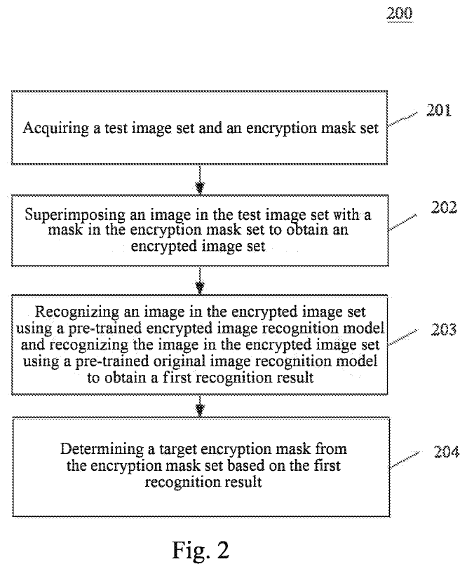

Further referring to FIG. 2, FIG. 2 illustrates a flow 200 of an embodiment of a method for determining an encryption mask according to the present disclosure. The method for determining an encryption mask includes the following steps:

Step 201, acquiring a test image set and an encryption mask set.

In this embodiment, an executing body (e.g., the server 105 shown in FIG. 1) of the method for determining an encryption mask may acquire the test image set and the encryption mask set. Here, the test image set is a set containing a plurality of test images, and each test image is a complete image. A test image may be an animal image, a plant image, or a human image, which is not limited in the present disclosure. The test image set may be a test image set formed by photographing a plurality of images, a test image set formed by selecting a plurality of images from a pre-stored image library, or a selected public image set, which is not limited in the present disclosure. For example, an LFW (Labeled Faces in the Wild) dataset may be selected as the test image set. The LFW dataset is a human face database completed and organized by the Computer Vision Laboratory of the University of Massachusetts Amherst (America). The LFW dataset contains more than 13,000 human face images in total that are collected from the Internet, and each image is marked with a name of a corresponding person.

In the technical solution of the present disclosure, the collection, storage, use, processing, transmission, provision, disclosure, etc. of the personal information of a user all comply with the provisions of the relevant laws and regulations, and do not violate public order and good customs.

The encryption mask set is a set containing a plurality of encryption masks, and each encryption mask has a different shape. An encryption mask may occlude an image, such that the image cannot show all the image features, thus achieving an encryption effect. The encryption mask set may be an encryption mask set formed by selecting a plurality of masks from a pre-stored mask library, an encryption mask set formed by manually drawing a plurality of masks, an encryption mask set formed by specifying masks of a plurality of shapes, or a selected public mask set, which is not limited in the present disclosure. For example, the irregular mask dataset introduced by NVIDIA may be selected as the encryption mask set. The masks in the irregular mask dataset have many shapes and have mask areas different from each other, and thus the irregular mask dataset is a widely applied mask dataset.

Step 202, superimposing an image in the test image set with a mask in the encryption mask set to obtain an encrypted image set.

In this embodiment, the executing body may superimpose the image in the test image set with the mask in the encryption mask set to obtain the encrypted image set. Here, each image in the test image set can be represented by a two-dimensional matrix array, and each element in the array has a specific position (x,y) and an amplitude f (x,y).

For example, the amplitude of a grayscale image represents the grayscale value of the image, 0 represents a pure black color, 255 represents a pure white color, and the numbers in a descending order between 0-255 represent transition colors from the pure black color to the pure white color. Each amplitude of a color image has three components: red, green and blue, 0 means that there is no corresponding primary color in a pixel, and 255 means that the corresponding primary color in the pixel takes a maximum value. Each mask in the encryption mask set may alternatively be represented by a two-dimensional matrix array, and the dimension of the two-dimensional matrix array of each mask is the same as that of the two-dimensional matrix array of each test image. Here, the numerical value of a region corresponding to a mask is 0, and the numerical value of a region corresponding to a non-mask is 1. The image in the test image set is superimposed with the mask in the encryption mask set, that is, the two-dimensional matrix array corresponding to the test image is superimposed and then computed with the two-dimensional matrix array corresponding to the encryption mask. For example, the image in the test image set is a grayscale image. The test image is superimposed with the encryption mask, that is, the two-dimensional matrix array corresponding to the test image is matrix-multiplied by the two-dimensional matrix array corresponding to the encryption mask, and a calculation result is an encrypted image. The numerical value of the encrypted image in the region corresponding to the mask is 0, and the numerical value of the encrypted image in the region corresponding to the non-mask is the original amplitude of the test image. Therefore, the encrypted image only shows the image of the non-mask region, rather than the complete test image, thus achieving the effect of encrypting the test image.

The image in the test image set is superimposed with the mask in the encryption mask set, that is, all the images in the test image set are superimposed with each mask in the encryption mask set. For example, the encryption mask set includes M masks, and the test image set includes N images. The images in the test image set are superimposed with the masks in the encryption mask set to obtain M*N encrypted images, and the M*N encrypted images constitute the encrypted image set. Here, M and N are both natural numbers.

Step 203, recognizing an image in the encrypted image set using a pre-trained encrypted image recognition model and recognizing the image in the encrypted image set using a pre-trained original image recognition model, to obtain a first recognition result.

In this embodiment, after obtaining the encrypted image set, the executing body may recognize the image in the encrypted image set to obtain the first recognition result. Here, both the pre-trained encrypted image recognition model and the pre-trained original image recognition model can recognize an encrypted image, and the network structures of the pre-trained encrypted image recognition model and the pre-trained original image recognition model can adopt a residual network. The residual network can effectively avoid the gradient disappearance problem caused by the increase of the number of layers in a deep neural network, and thus, the depth of the network can be greatly increased. In the residual network, the output of an average pooling layer may be set to a 512-dimensional vector before a fully connected layer, thus making it possible for the residual network to perform recognition on different encrypted images. By using the pre-trained encrypted image recognition model and the pre-trained original image recognition model to recognize each image in the encrypted image set, two recognition results corresponding to each image can be obtained. The recognition results may refer to a name of a target object in the image. The two recognition results corresponding to each image may be respectively compared with preset image recognition results, and thus, two recognition similarities corresponding to each image may be calculated. The two recognition similarities of each image in the encrypted image set are determined as the first recognition result.

Step 204, determining a target encryption mask from the encryption mask set based on the first recognition result.

In this embodiment, after obtaining the first recognition result, the executing body may determine the target encryption mask from the encryption mask set based on the first recognition result. Specifically, an image may be taken as the target encrypted image, where a recognition similarity of the image corresponding to the encrypted image recognition model is higher than an encryption threshold and a recognition similarity of the image corresponding to the original image recognition model is lower than an original threshold. Since an encrypted image is obtained according to a mask in the encryption mask set, a mask corresponding to the target encrypted image is the target encryption mask. For example, if the encryption threshold is equal to 80% and the original threshold is equal to 50%, an encrypted image can be found, where a recognition similarity of the encrypted image corresponding to the encrypted image recognition model is higher than 80% and a recognition similarity of the encrypted image corresponding to the original image recognition model is lower than 50%. A mask corresponding to this encrypted image is the target encryption mask.

According to the method for determining an encryption mask provided in the embodiment of the present disclosure, the test image set and the encryption mask set are first acquired. Then, the image in the test image set is superimposed with the mask in the encryption mask set to obtain the encrypted image set. Finally, the image in the encrypted image set is recognized using the pre-trained encrypted image recognition model and the pre-trained original image recognition model, and the target encryption mask is determined from the encryption mask set. Through the pre-trained encrypted image recognition model and the pre-trained original image recognition model, the target encryption mask is determined from the encryption mask set, which makes it possible for the target encryption mask to ensure the recognition precision of the encrypted image, and improves the security and privacy of the originally inputted image at the same time.

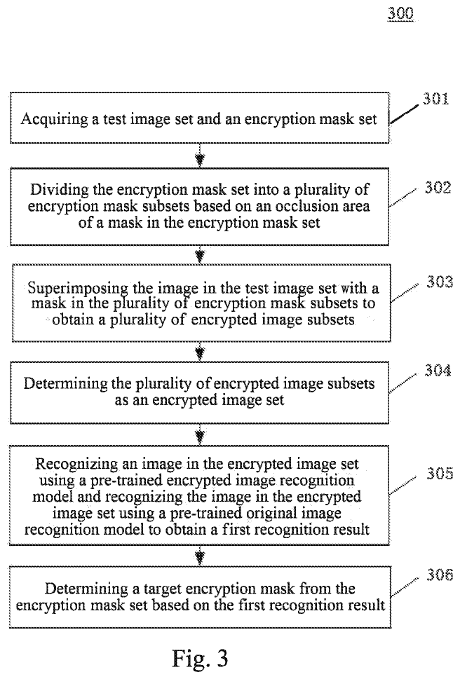

Further referring to FIG. 3, FIG. 3 illustrates a flow 300 of another embodiment of the method for determining an encryption mask according to the present disclosure. The method for determining an encryption mask includes the following steps:

Step 301, acquiring a test image set and an encryption mask set.

In this embodiment, the specific operation of step 301 is described in detail in step 201 in the embodiment shown in FIG. 2, and thus will not be repeatedly described here.

Step 302, dividing the encryption mask set into a plurality of encryption mask subsets based on an occlusion area of a mask in the encryption mask set.

In this embodiment, after acquiring the encryption mask set, the executing body may divide the encryption mask set into the plurality of encryption mask subsets based on the occlusion area of the mask in the encryption mask set. Here, the shape of each mask in the encryption mask set is different, and thus, the occlusion area of each mask is different, too. If each mask and an image with the same dimension as each mask are superimposed, the encryption mask set may be divided into a plurality of encryption mask subsets based on the ratio of an occlusion region of each mask to an area of a whole image. Here, the ratio of the occlusion region of each mask to the area of the whole image is a numerical value greater than 0 and less than 1. For example, taking 0.1 as an interval, the encryption mask set may be divided into six encryption mask subsets whose ratios of the occlusion areas respectively belong to [0.01-0.1], [0.1-0.2], [0.2-0.3], [0.3-0.4], [0.4-0.5] and [0.5-0.6]. For example, the encryption mask subset whose ratios of the occlusion areas belong to [0.5-0.6] contains all masks in the encryption mask set whose ratios of the occlusion areas are between 0.5 and 0.6.

Step 303, superimposing an image in the test image set with a mask in the plurality of encryption mask subsets to obtain a plurality of encrypted image subsets.

In this embodiment, after obtaining the plurality of encryption mask subsets, the executing body may further determine the plurality of encrypted image subsets. Specifically, images in the test image set are superimposed with a mask in each encryption mask subset, to obtain an encrypted image subset corresponding to each encryption mask subset. For example, the test image set contains M images, there are N encryption mask subsets in total, and each encryption mask subset contains Ni masks.

Images in the test image set are superimposed with masks in each encryption mask subset, that is, all the images in the test image set are superimposed with each mask in each encryption mask subset, to obtain Ni*M encrypted images. The Ni*M encrypted images constitute one encrypted image subset. There are N encryption mask subsets, and accordingly, there are N encrypted image subsets. Here, M and N are both natural numbers, and i is a natural number between 1 and N. Each test image is superimposed with each mask, that is, a two-dimensional matrix array corresponding to a test image is matrix-multiplied by a two-dimensional matrix array corresponding to a mask.

Step 304, determining the plurality of encrypted image subsets as an encrypted image set.

In this embodiment, the executing body may determine the plurality of encrypted image subsets as the encrypted image set. That is, the encrypted image set is composed of the plurality of encrypted image subsets, and each encrypted image subset consists of the varying number of encrypted images.

Step 305, recognizing an image in the encrypted image set using a pre-trained encrypted image recognition model and recognizing the image in the encrypted image set using a pre-trained original image recognition model, to obtain a first recognition result.

Step 306, determining a target encryption mask from the encryption mask set based on the first recognition result.

In this embodiment, the specific operations of steps 305-306 are described in detail in steps 203-204 in the embodiment shown in FIG. 2, and thus will not be repeatedly described here.

It can be seen from FIG. 3 that, as compared with the embodiment corresponding to FIG. 2, according to the method for determining an encryption mask in this embodiment, the encryption mask set is divided into the plurality of encryption mask subsets based on the occlusion area of the mask in the encryption mask set, and the plurality of corresponding encrypted image subsets are obtained, which facilitates narrowing the data range of the subsequent steps and improves the efficiency of determining the encryption mask.

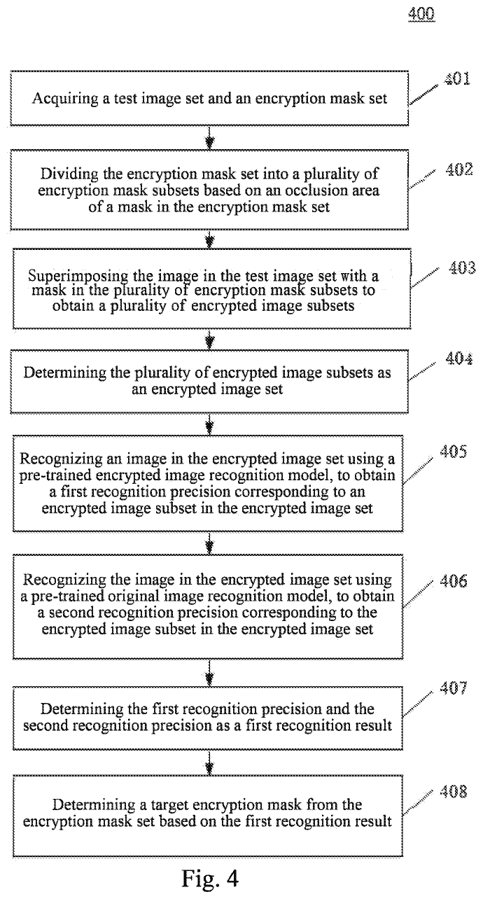

Further referring to FIG. 4, FIG. 4 illustrates a flow 400 of another embodiment of the method for determining an encryption mask according to the present disclosure. The method for determining an encryption mask includes the following steps:

Step 401, acquiring a test image set and an encryption mask set.

In this embodiment, the specific operation of step 401 is described in detail in step 201 in the embodiment shown in FIG. 2, and thus will not be repeatedly described here.

Step 402, dividing the encryption mask set into a plurality of encryption mask subsets based on an occlusion area of a mask in the encryption mask set.

Step 403, superimposing an image in the test image set with a mask in the plurality of encryption mask subsets to obtain a plurality of encrypted image subsets.

Step 404, determining the plurality of encrypted image subsets as an encrypted image set.

In this embodiment, the specific operations of steps 402-404 are described in detail in steps 302-304 in the embodiment shown in FIG. 3, and thus will not be repeatedly described here.

Step 405, recognizing an image in the encrypted image set using a pre-trained encrypted image recognition model, to obtain a first recognition precision corresponding to each encrypted image subset in the encrypted image set.

In this embodiment, the executing body may recognize the image in the encrypted image set using the pre-trained encrypted image recognition model. Specifically, the pre-trained encrypted image recognition model may be used to recognize an image in each encrypted image subset. An average value of recognition precisions corresponding to all the images in the encrypted image subset may be taken as a recognition precision corresponding to the encrypted image subset. Each encrypted image subset is recognized 5 times, and accordingly, an average value of 5 recognition precisions is taken as the first recognition precision corresponding to the encrypted image subset.

Step 406, recognizing the image in the encrypted image set using a pre-trained original image recognition model, to obtain a second recognition precision corresponding to each encrypted image subset in the encrypted image set.

In this embodiment, the executing body may recognize the image in the encrypted image set using the pre-trained original image recognition model. Specifically, the pre-trained original image recognition model may be used to recognize the image in each encrypted image subset. An average value of recognition precisions corresponding to all the images in the encrypted image subset may be taken as a recognition precision corresponding to the encrypted image subset. Each encrypted image subset is recognized 5 times, and accordingly, an average value of 5 recognition precisions is taken as the second recognition precision corresponding to the encrypted image subset.

Step 407, determining the first recognition precision and the second recognition precision as a first recognition result.

In this embodiment, after obtaining the first recognition precision and the second recognition precision, the executing body determines the first recognition precision and the second recognition precision as the first recognition result.

Step 408, determining a target encryption mask from the encryption mask set based on the first recognition result.

In this embodiment, the specific operation of step 408 is described in detail in step 204 in the embodiment shown in FIG. 2, and thus will not be repeatedly described here.

It can be seen from FIG. 4 that, as compared with the embodiment corresponding to FIG. 2, according to the method for determining an encryption mask in this embodiment, the target encryption mask is determined from the encryption mask set based on the first recognition precision and the second recognition precision, such that the encrypted image obtained through the target encryption mask cannot be applied to the widely used original image recognition model even if the encrypted image is leaked. Thus, the security of the encrypted image is improved.

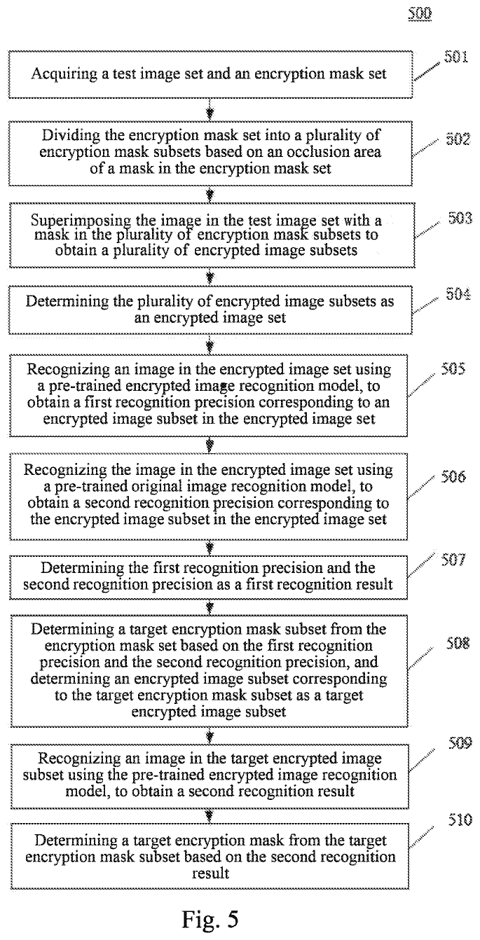

Further referring to FIG. 5, FIG. 5 illustrates a flow 500 of another embodiment of the method for determining an encryption mask according to the present disclosure. The method for determining an encryption mask includes the following steps:

Step 501, acquiring a test image set and an encryption mask set.

In this embodiment, the specific operation of step 501 is described in detail in step 201 in the embodiment shown in FIG. 2, and thus will not be repeatedly described here.

Step 502, dividing the encryption mask set into a plurality of encryption mask subsets based on an occlusion area of a mask in the encryption mask set.

Step 503, superimposing an image in the test image set with a mask in the plurality of encryption mask subsets to obtain a plurality of encrypted image subsets.

Step 504, determining the plurality of encrypted image subsets as an encrypted image set.

In this embodiment, the specific operations of steps 502-504 are described in detail in steps 302-304 in the embodiment shown in FIG. 3, and thus will not be repeatedly described here.

Step 505, recognizing an image in the encrypted image set using a pre-trained encrypted image recognition model, to obtain a first recognition precision corresponding to each encrypted image subset in the encrypted image set.

Step 506, recognizing the image in the encrypted image set using a pre-trained original image recognition model, to obtain a second recognition precision corresponding to each encrypted image subset in the encrypted image set.

Step 507, determining the first recognition precision and the second recognition precision as a first recognition result.

In this embodiment, the specific operations of steps 505-507 are described in detail in steps 405-407 in the embodiment shown in FIG. 4, and thus will not be repeatedly described here.

Step 508, determining a target encryption mask subset from the encryption mask set based on the first recognition precision and the second recognition precision, and determining an encrypted image subset corresponding to the target encryption mask subset as a target encrypted image subset.

In this embodiment, after acquiring the first recognition result, the executing body may determine the target encryption mask subset from the encryption mask set based on the first recognition result. Specifically, the first recognition result includes the first recognition precision and second recognition precision corresponding to each encrypted image subset in the encrypted image set. Since an image in an encrypted image subset is obtained according to a mask in a corresponding encryption mask subset, the first recognition precision and second recognition precision corresponding to the encrypted image subset are the first recognition precision and second recognition precision corresponding to the corresponding encryption mask subset. A first recognition precision and a second recognition precision that correspond to a given encryption mask subset are compared, and an encryption mask subset is taken as the target encryption mask subset, where a difference between the first recognition precision correspond to the encryption mask subset and the second recognition precision correspond to the encryption mask subset is greater than a first threshold. The target encryption mask subset may refer to one encryption mask subset, or a plurality of encryption mask subsets. The first threshold is a percentage greater than 0 and less than 100. For example, the first threshold is equal to 30%. For example, as shown in Table 1, a first recognition precision and second recognition precision corresponding to each encryption mask subset are collected in Table 1. Table 1 has 3 rows in total, and there are totally 7 encryption mask subsets in the first row, which are respectively a non-mask subset and encryption mask subsets whose ratios of the occlusion areas respectively belong to [0.01-0.1], [0.1-0.2], [0.2-0.3], [0.3-0.4], [0.4-0.5] and [0.5-0.6]. In the second row, there are first recognition precisions corresponding to the encryption mask subsets. In the third row, there are second recognition precisions corresponding to the encryption mask subsets. It can be seen from Table 1 that two encryption mask subsets whose ratios of the occlusion areas respectively belong to [0.4-0.5] and [0.5-0.6] should be selected as target encryption mask subsets, because in these two encryption mask subsets, the first recognition precisions corresponding to the pre-trained encrypted image recognition model are high, and at the same time, the second recognition precisions corresponding to the pre-trained original image recognition model are low. An encrypted image obtained using a mask in these two encryption mask subsets cannot be applied to the widely used original image recognition model even if the encrypted image is leaked. Thus, the security of the encrypted image is improved.

TABLE 1
Comparison Table between First Recognition Precision and Second Recognition
Precision

| | Original | | | | | | |
|---|---|---|---|---|---|---|---|
| | image | [0.01-0.1] | [0.1-0.2] | [0.2-0.3] | [0.3-0.4] | [0.4-0.5] | [0.5-0.6] |
| First recognition | 92.1% | 91.89% | 91.32% | 90.49% | 88.08% | 87.76% | 83.62% |
| precision | | | | | | | |
| Second recognition | 93.2% | 90.3% | 83.71% | 73.54% | 62.08% | 56.03% | 53.63% |
| precision | | | | | | | |

After the target encryption mask subset is determined, the encrypted image subset corresponding to the target encryption mask subset is determined as the target encrypted image subset.

Step 509, recognizing an image in the target encrypted image subset using the pre-trained encrypted image recognition model, to obtain a second recognition result.

In this embodiment, after acquiring the target encrypted image subset, the executing body may recognize the image in the target encrypted image subset using the pre-trained encrypted image recognition model. Specifically, a recognition result corresponding to each image in the target encrypted image subset can be obtained, and the recognition result may refer to a name of a target object in the image. The recognition result corresponding to each image is compared with a preset image recognition result, and a recognition similarity corresponding to each image is calculated. The recognition similarity of each image in the target encrypted image subset is determined as the second recognition result.

Step 510, determining a target encryption mask from the target encryption mask subset based on the second recognition result.

In this embodiment, after acquiring the second recognition result, the executing body may determine the target encryption mask from the target encryption mask subset based on the second recognition result. Specifically, a corresponding image having a recognition similarity higher than a similarity threshold in the target encrypted image subset may be taken as the target encrypted image. Since an encrypted image is obtained according to a mask in the encryption mask set, a mask corresponding to the target encrypted image is the target encryption mask. For example, if the similarity threshold is equal to 80%, a corresponding encrypted image having a recognition similarity higher than 80% in the target encrypted image subset can be found, and a mask corresponding to this encrypted image is the target encryption mask. The target encryption mask may refer to one encryption mask or a plurality of encryption masks.

It can be seen from FIG. 5 that, as compared with the embodiment corresponding to FIG. 4, according to the method for determining an encryption mask in this embodiment, the target encryption mask subset is first determined from the encryption mask set based on the first recognition result, and the encrypted image subset corresponding to the target encryption mask subset is determined as the target encrypted image subset. Then, the image in the target encrypted image subset is recognized using the pre-trained encrypted image recognition model, to obtain the second recognition result. Finally, the target encryption mask is determined from the target encryption mask subset based on the second recognition result. The target encryption mask subset is determined, and then, the target encryption mask is determined from the target encryption mask subset, thus improving the efficiency of determining the target encryption mask.

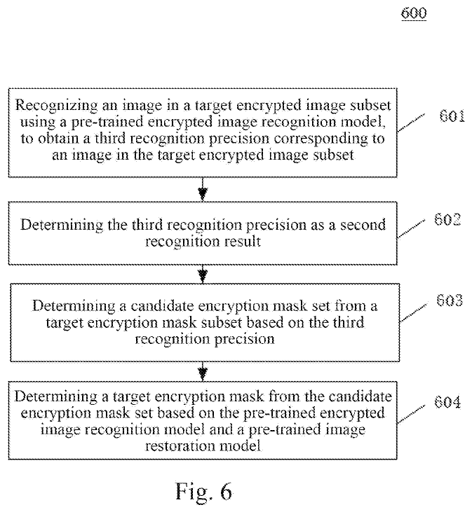

Further referring to FIG. 6, FIG. 6 illustrates a flow 600 of an embodiment in which a target encryption mask is determined from a target encryption mask subset, according to the present disclosure. A method of determining the target encryption mask from the target encryption mask subset includes the following steps:

Step 601, recognizing an image in a target encrypted image subset using a pre-trained encrypted image recognition model, to obtain a third recognition precision corresponding to each image in the target encrypted image subset.

In this embodiment, the executing body may recognize the image in the target encrypted image subset using the pre-trained encrypted image recognition model. Specifically, each image in the target encrypted image subset may be recognized using the pre-trained encrypted image recognition model, to obtain the third recognition precision of each image.

Step 602, determining the third recognition precision as a second recognition result.

In the embodiment, after obtaining the third recognition precision corresponding to each image in the target encrypted image subset, the executing body may determine the third recognition precision corresponding to each image in the target encrypted image subset as the second recognition result.

Step 603, determining a candidate encryption mask set from a target encryption mask subset based on the third recognition precision.

In this embodiment, after obtaining the third recognition precision, the executing body may determine the candidate encryption mask set from the target encryption mask subset based on the third recognition precision. Since each image in the target encrypted image subset is obtained according to a corresponding mask in the target encryption mask subset, the third recognition precision of each image in the target encrypted image subset is the third recognition precision corresponding to the corresponding mask in the target encryption mask subset. The target encrypted image subset may refer to one encrypted image subset or a plurality of encrypted image subsets. In each target encryption mask subset, third recognition precisions corresponding masks in the target encryption mask subset are arranged in a descending order of precision values, and at least two third recognition precisions are selected. Masks corresponding to the at least two third recognition precisions are determined as the candidate encryption mask set in the target encryption mask subset. The candidate encryption mask set in each target encryption mask subset constitutes a candidate encryption mask set.

Step 604, determining a target encryption mask from the candidate encryption mask set based on the pre-trained encrypted image recognition model and a pre-trained image restoration model.

In this embodiment, after determining the candidate encryption mask set, the executing body may obtain an encrypted image corresponding to a candidate encryption mask. The pre-trained image restoration model is a model that can restore the encrypted image. For example, the image restoration model may be an RFR-Net (Recurrent Feature Reasoning Net) model. The model is designed with a plug-and-play recurrent feature reasoning module RFR, which can reduce the to-be-filled range layer by layer and realize the reuse of model parameters. The model is further designed with a knowledge consistency attention mechanism. The encrypted image may be inputted into the pre-trained image restoration model to obtain an encrypted image after a restoration. The encrypted images before and after the restoration are recognized based on the pre-trained encrypted image recognition model, to determine the target encryption mask from the candidate encryption mask set. The target encryption mask may refer to one encryption mask or a plurality of encryption masks.

It can be seen from FIG. 6 that, as compared with the embodiment corresponding to FIG. 5, according to the method of determining the target encryption mask from the target encryption mask subset in this embodiment, the candidate encryption mask set is first determined from the target encryption mask subset according to the third recognition precision corresponding to each image in the target encrypted image subset, which further narrows the range from which the target encryption mask is determined, and improves the efficiency of determining the target encryption mask. Then, the target encryption mask is determined from the candidate encryption mask set based on the pre-trained encrypted image recognition model and the pre-trained image restoration model, such that the encrypted image obtained through the target encryption mask cannot be applied to the widely used original image recognition model, and at the same time, even if the encrypted image is first restored using the image restoration model and then recognized, the real information of the encrypted image cannot be recognized. Thus, the security of the encrypted image is further improved.

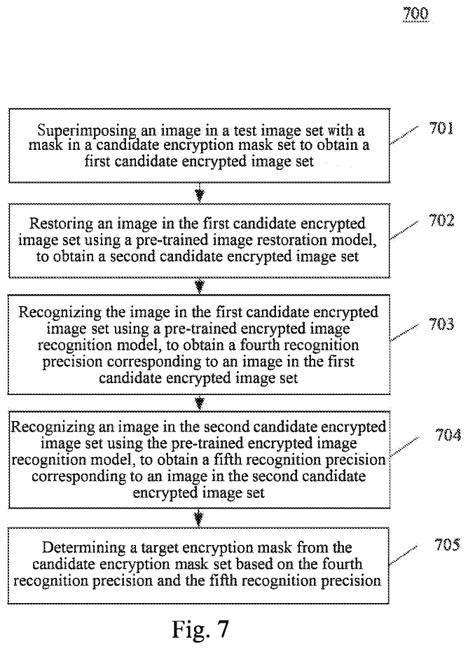

Further referring to FIG. 7, FIG. 7 illustrates a flow 700 of an embodiment in which a target encryption mask is determined from a candidate encryption mask set based on a pre-trained encrypted image recognition model and a pre-trained image restoration model, according to the present disclosure. The method of determining the target encryption mask includes the following steps:

Step 701, superimposing an image in a test image set with a mask in a candidate encryption mask set to obtain a first candidate encrypted image set.

In this embodiment, the executing body may superimpose the image in the test image set with the mask in the candidate encryption mask set to obtain the first candidate encryption image set. Specifically, all the images in the test image set are superimposed with each mask in the candidate encryption mask set. For example, the test image set includes M images, and the candidate encryption mask set includes N masks. The images in the test image set are superimposed with the masks in the candidate encryption mask set to obtain M*N encrypted images, and the M*N encrypted images constitute the first candidate encrypted image set. Here, M and N are both natural numbers. An image in the test image set is superimposed with a mask in the candidate encryption mask set, that is, a two-dimensional matrix array corresponding to the test image is matrix-multiplied by a two-dimensional matrix array corresponding to the mask.

Step 702, restoring an image in the first candidate encrypted image set using a pre-trained image restoration model, to obtain a second candidate encrypted image set.

In this embodiment, after obtaining the first candidate encrypted image set, the executing body may restore each encrypted image in the first candidate encrypted image set using the pre-trained image restoration model, to obtain restored images, where the number of the restored images is the same as the number of the images in the first candidate encrypted image set. The restored images with the same number are used as the second candidate encrypted image set.

Step 703, recognizing the image in the first candidate encrypted image set using a pre-trained encrypted image recognition model, to obtain a fourth recognition precision corresponding to each image in the first candidate encrypted image set.

In this embodiment, after obtaining the first candidate encrypted image set, the executing body may recognize the image in the first candidate encrypted image set. Specifically, each image in the first candidate encrypted image set may be recognized using the pre-trained encrypted image recognition model, to obtain the fourth recognition precision of each image.

Step 704, recognizing an image in the second candidate encrypted image set using the pre-trained encrypted image recognition model, to obtain a fifth recognition precision corresponding to each image in the second candidate encrypted image set.

In this embodiment, after obtaining the second candidate encrypted image set, the executing body may recognize the image in the second candidate encrypted image set. Specifically, each image in the second candidate encrypted image set may be recognized using the pre-trained encrypted image recognition model, to obtain the fifth recognition precision of each image.

Step 705, determining a target encryption mask from the candidate encryption mask set based on the fourth recognition precision and the fifth recognition precision.

In this embodiment, after acquiring the fourth recognition precision and the fifth recognition precision, the executing body may determine the target encryption mask from the candidate encryption mask set based on the fourth recognition precision and the fifth recognition precision. Since each image in the first candidate encrypted image set is obtained according to a corresponding mask in the candidate encryption mask set, the fourth recognition precision of each image in the first candidate encrypted image set is the fourth recognition precision corresponding to a corresponding mask in the candidate encryption mask set. Since each image in the second candidate encrypted image set is obtained according to each image in the first candidate encrypted image set, and each image in the first candidate encrypted image set is obtained according to a corresponding mask in the candidate encryption mask set. Therefore, the fifth recognition precision of each image in the second candidate encrypted image set is the fifth recognition precision corresponding to a corresponding mask in the candidate encryption mask set. The fourth recognition precision and the fifth recognition precision that correspond to a given encryption mask in the candidate encryption mask set are compared, and an encryption mask is taken as the target encryption mask, where a difference between the fourth recognition precision corresponding to the encryption mask and the fifth recognition precision corresponding to the encryption mask is greater than a second threshold. The target encryption mask may refer to one encryption mask, or a plurality of encryption masks. The second threshold is a percentage greater than 0 and less than 100. For example, the second threshold is equal to 7%. For example, as shown in Table 2, a fourth recognition precision and fifth recognition precision corresponding to each encryption mask in the candidate encryption mask set are collected in Table 2. Table 2 has 7 rows in total. The first row is the table header, the second to seventh rows are a fourth recognition precision and a fifth recognition precision that correspond to each encryption mask, and a difference between the two recognition precisions. It can be seen from the first column of Table 2 that, the selected target encrypted image subsets are two encryption mask subsets whose ratios of occlusion areas respectively belong to [0.4-0.5] and [0.5-0.6], and the selected candidate encryption mask set is composed of masks No. 1175, No. 1403 and No. 0565 in the encryption mask subset whose ratios of occlusion areas belong to [0.4-0.5] and masks No. 1584, No. 0007 and No. 1478 in the encryption mask subset whose ratios of occlusion areas belong to [0.5-0.6]. As can be seen from Table 2, the mask No. 1478 should be selected as the target encryption mask, because with the mask No. 1478, the recognition precision can reach 85.57% before the restoration, and at the same time, the recognition precision is reduced by 7.02% after the restoration, indicating that an encrypted image superimposed with the mask No. 1478 not only has a high recognition precision, but also has a certain ability to resist an attack from a restoration network, thereby further improving the security of the encrypted image.

TABLE 2
Comparison Table between Fourth Recognition Precision and Fifth Recognition Precision

| Subset/ | Fourth | Fifth | |
|---|---|---|---|
| Serial | recognition | recognition | |
| number | precision | precision | Difference |
| [0.4-0.5]/1175 | 90.23% | 87.53% | 2.7% |
| [0.4-0.5]/1403 | 88.9% | 84.42% | 4.48% |
| [0.4-0.5]/0565 | 88.13% | 85.63% | 2.5% |
| [0.5-0.6]/1584 | 85.3% | 81.67% | 3.63% |
| [0.5-0.6]/0007 | 85.82% | 80.32% | 5.5% |
| [0.5-0.6]/1478 | 85.57% | 78.55% | 7.02% |

It can be seen from FIG. 7 that, as compared with the embodiment corresponding to FIG. 6, according to the method of determining the target encryption mask in this embodiment, the target encryption mask is determined by comparing the recognition precisions of the encrypted images before and after the restoration, which ensures that the encrypted image obtained using the target encryption mask not only has a high recognition precision, but also has a certain capability to resist and repair a network attack. Thus, the security of the encrypted image is further improved.

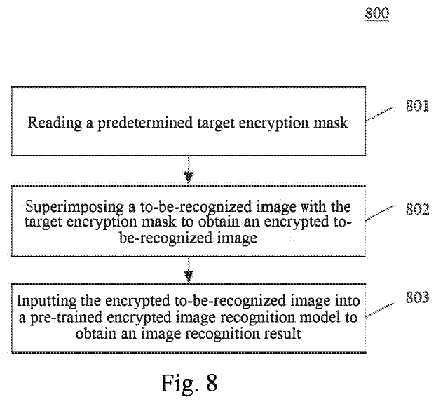

Further referring to FIG. 8, FIG. 8 illustrates a flow 800 of an embodiment of a method for recognizing an image according to the present disclosure. The method for recognizing an image includes the following steps:

Step 801, reading a predetermined target encryption mask.

In this embodiment, the encryption mask is obtained by the method for determining an encryption mask shown in FIGS. 2-7. The executing body may read the predetermined target encryption mask. Here, each target encryption mask is a two-dimensional matrix array, and the two-dimensional matrix array can be directly read. If the target encryption mask refers to one mask, one two-dimensional matrix array is read. If the target encryption mask refers to a plurality of masks, a plurality of two-dimensional matrix arrays is read.

Step 802, superimposing a to-be-recognized image with the target encryption mask to obtain an encrypted to-be-recognized image.

In this embodiment, after reading the predetermined target encryption mask, the executing body may superimpose the to-be-recognized image with the target encryption mask to obtain the encrypted to-be-recognized image. If the target encryption mask refers to one mask, the to-be-recognized image is superimposed with this mask. If the target encryption mask refers to a plurality of masks, a pre-tested target encryption mask with a highest recognition precision may be selected, or a mask may be randomly selected from the target encryption mask, and then the to-be-recognized image is superimposed with the mask. The to-be-recognized image is superimposed with the target encryption mask, that is, a two-dimensional matrix array of the to-be-recognized image is matrix-multiplied by a two-dimensional matrix array of the mask selected from the target encryption mask, and a calculation result is an encrypted to-be-recognized image.

Step 803, inputting the encrypted to-be-recognized image into a pre-trained encrypted image recognition model to obtain an image recognition result.

In this embodiment, after obtaining the encrypted to-be-recognized image, the executing body may input the encrypted to-be-recognized image into the pre-trained encrypted image recognition model for recognition. Here, the pre-trained encrypted image recognition model may recognize a content in the encrypted to-be-recognized image, and the image content recognized by the encrypted image recognition model is used as an image recognition result. The image recognition result may refer to the kind of an animal or plant, or the identity of a person, which is not limited in the present disclosure.

In the technical solution of the present disclosure, the collection, storage, use, processing, transmission, provision, disclosure, etc. of the personal information of a user all comply with the provisions of the relevant laws and regulations, and do not violate public order and good customs.

As can be seen from FIG. 8, according to the method for recognizing an image in this embodiment, the to-be-recognized image may be superimposed with the target encryption mask to obtain the encrypted to-be-recognized image, and then, the encrypted to-be-recognized image is recognized, thus protecting the privacy of the to-be-recognized image and improving the security of the to-be-recognized image.

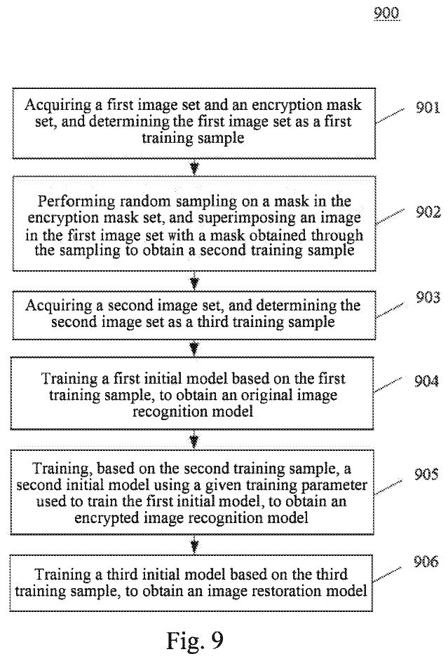

Further referring to FIG. 9, FIG. 9 illustrates a flow 900 of an embodiment of a method for training a model according to the present disclosure. The method for training a model includes the following steps:

Step 901, acquiring a first image set and an encryption mask set, and determining the first image set as a first training sample.

In this embodiment, the executing body may acquire the first image set and the encryption mask set. Here, the first image set is a set containing a plurality of images, and each image is a complete image. The image in the first image set may be an animal image, a plant image, or a human image, which is not limited in the present disclosure.

The first image set may be a first image set formed by photographing a plurality of images, a first image set formed by selecting a plurality of images from a pre-stored image library, or a selected public image set, which is not limited in the present disclosure. For example, the public human face dataset VGGface2 is selected as the first image set. VGGface2 is a face dataset published by the Vision Group of the University of Oxford. The dataset contains human face pictures of different poses, ages, lighting and backgrounds, of which about 59.7% are male. In addition to identity information, the dataset further includes human face boxes, 5 key points, and estimated ages and poses. The first image set is determined as the first training sample.

In the technical solution of the present disclosure, the collection, storage, use, processing, transmission, provision, disclosure, etc. of the personal information of a user all comply with the provisions of the relevant laws and regulations, and do not violate public order and good customs.

In this embodiment, the specific operation of the encryption mask set is described in detail in step 201 in the embodiment shown in FIG. 2, and thus will not be repeatedly described here.

Step 902, performing random sampling on a mask in the encryption mask set, and superimposing an image in the first image set with a mask obtained through the sampling to obtain a second training sample.

In this embodiment, the executing body may perform the random sampling on the mask in the encryption mask set, and superimposing the image in the first image set with the mask obtained through the sampling to obtain the second training sample. Here, the random sampling performed on the mask in the encryption mask set refers to that each mask in the encryption mask set has the same probability of being extracted. At least two masks are randomly extracted from the encryption mask set, and all the images in the first image set are superimposed with each extracted mask, that is, a two-dimensional matrix array of each image in the first image set is matrix- by a two-dimensional matrix array of each mask. A calculation result is used as the second training sample.

Step 903, acquiring a second image set, and determining the second image set as a third training sample.

In this embodiment, the executing body may acquire the second image set. Here, the second image set is a set containing a plurality of images, and each image is a partially occluded image. The image in the second image set may be an animal image, a plant image, or a human image, which is not limited in the present disclosure. The second image set may be a second image set obtained by photographing a plurality of images and then superimposing a mask on the photographed images, a second image set obtained by selecting a plurality of images from a pre-stored image library and then superimposing a mask on the selected images, or a second image set obtained by selecting a public image set and then superimposing a mask on images in the image set, which is not limited in the present disclosure. For example, the public image set CelebA (CelebFaces Attribute) may be selected. CelebA is openly provided by the Chinese University of Hong Kong, and is widely used in human face-related computer vision training tasks. CelebA may be used for human face attribute identification training, human face detection training, etc. The second image set is obtained by superimposing a mask on images in the CelebA dataset. The second image set is determined as the third training sample.

In the technical solution of the present disclosure, the collection, storage, use, processing, transmission, provision, disclosure, etc. of the personal information of a user all comply with the provisions of the relevant laws and regulations, and do not violate public order and good customs.

Step 904, training a first initial model based on the first training sample to obtain an original image recognition model.

In this embodiment, the executing body may train the first initial model based on the first training sample, to obtain the original image recognition model. Here, the network structure of the first initial model may adopt a residual network. The residual network can effectively avoid the gradient disappearance problem caused by the increase of the number of layers in a deep neural network, and thus, the depth of the network can be greatly increased. The first initial model is trained based on the first training sample, to obtain the original image recognition model. When a complete image is inputted into the original image recognition model, the original image recognition model can accurately recognize a target in the inputted image.

Step 905, training, based on the second training sample, a second initial model using a given training parameter used to train the first initial model, to obtain an encrypted image recognition model.

In this embodiment, the executing body may train the second initial model based on the second training sample, to obtain the encrypted image recognition model. Here, the second training sample is obtained by superimposing a mask on the first training sample. When the second initial model is trained based on the second training sample, the second initial model is trained using the given training parameter used to train the first initial model and is trained for a given number of rounds, thus obtaining the encrypted image recognition model. When a partially occluded image is inputted into the encrypted image recognition model, the encrypted image recognition model can accurately recognize a target in the inputted image.

Step 906, training a third initial model based on the third training sample, to obtain an image restoration model.

In this embodiment, the executing body may train the third initial model based on the third training sample, to obtain the image restoration model. Here, the third initial model may be a model that can restore an occluded image. The third initial model is trained based on the third training sample, to obtain the image restoration model. When a partially occluded image is inputted into the image restoration model, the image restoration model can output a complete image.

As can be seen from FIG. 9, according to the method for training a model in this embodiment, the original image recognition model, the encrypted image recognition model and the image restoration model can be obtained. Based on the original image recognition model, the encrypted image recognition model and the image restoration model, an encryption mask that has a high recognition precision and can prevent the attack from the image restoration model can be determined, which improves the security of the original image.

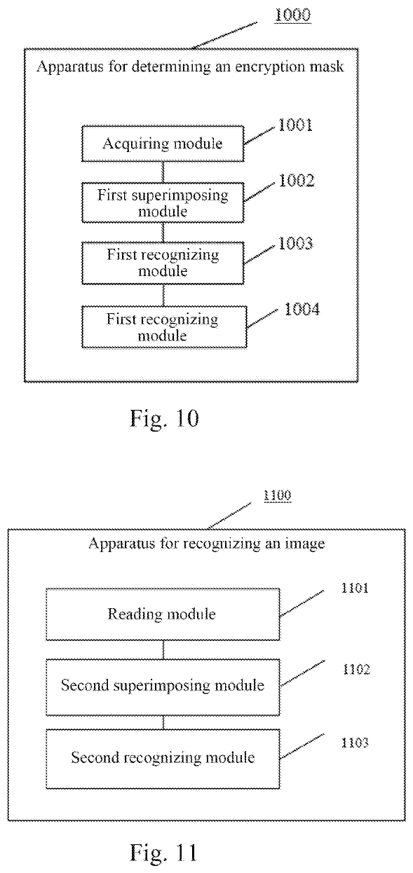

Further referring to FIG. 10, as an implementation of the method shown in the above drawing, the present disclosure provides an embodiment of an apparatus for determining an encryption mask. The embodiment of the apparatus corresponds to the embodiment of the method shown in FIG. 2. The apparatus may be applied in various electronic devices.

As shown in FIG. 10, an apparatus 1000 for determining an encryption mask in this embodiment may include: an acquiring module 1001, a first superimposing module 1002, a first recognizing module 1003 and a determining module 1004. Here, the acquiring module 1001 is configured to acquire a test image set and an encryption mask set. The first superimposing module 1002 is configured to superimpose an image in the test image set with a mask in the encryption mask set to obtain an encrypted image set. The first recognizing module 1003 is configured to recognize an image in the encrypted image set using a pre-trained encrypted image recognition model and recognize the image in the encrypted image set using a pre-trained original image recognition model to obtain a first recognition result. The determining module 1004 is configured to determine a target encryption mask from the encryption mask set based on the first recognition result.

In this embodiment, for specific processes of the acquiring module 1001, the first superimposing module 1002, the first recognizing module 1003 and the determining module 1004 in the apparatus 1000 for determining an encryption mask, and their technical effects, reference may be respectively made to relative descriptions of steps 201-204 in the corresponding embodiment of FIG. 2, and thus the specific processes and the technical effects will not be repeated here.

In some alternative implementations of this embodiment, the first superimposing module 1002 includes: a dividing submodule, configured to divide the encryption mask set into a plurality of encryption mask subsets based on an occlusion area of the mask in the encryption mask set; a superimposing submodule, configured to superimpose the image in the test image set with a mask in the plurality of encryption mask subsets to obtain a plurality of encrypted image subsets; and a first determining submodule, configured to determine the plurality of encrypted image subsets as the encrypted image set.

In some alternative implementations of this embodiment, the first recognizing module includes: a first recognizing submodule, configured to recognize the image in the encrypted image set using the pre-trained encrypted image recognition model, to obtain a first recognition precision corresponding to each encrypted image subset in the encrypted image set; a second recognizing submodule, configured to recognize the image in the encrypted image set using the pre-trained original image recognition model, to obtain a second recognition precision corresponding to each encrypted image subset in the encrypted image set; and a second determining submodule, configured to determine the first recognition precision and the second recognition precision as the first recognition result.

In some alternative implementations of this embodiment, the determining module 1004 includes: a third determining submodule, configured to determine a target encryption mask subset from the encryption mask set based on the first recognition precision and the second recognition precision, and determine an encrypted image subset corresponding to the target encryption mask subset as a target encrypted image subset; a third recognizing submodule, configured to recognize an image in the target encrypted image subset using the pre-trained encrypted image recognition model to obtain a second recognition result; and a fourth determining submodule, configured to determine the target encryption mask from the target encryption mask subset based on the second recognition result.

In some alternative implementations of this embodiment, the third recognizing submodule includes: a recognizing unit, configured to recognize the image in the target encrypted image subset using the pre-trained encrypted image recognition model, to obtain a third recognition precision corresponding to each image in the target encrypted image subset; and a first determining unit, configured to determine the third recognition precision as the second recognition result.

In some alternative implementations of this embodiment, the fourth determining submodule includes: a second determining unit, configured to determine a candidate encryption mask set from the target encryption mask subset based on the third recognition precision; and a third determining unit, configured to determine the target encryption mask from the candidate encryption mask set based on the pre-trained encrypted image recognition model and a pre-trained image restoration model.

In some alternative implementations of this embodiment, the third determining unit includes: a superimposing subunit, configured to superimpose the image in the test image set with a mask in the candidate encryption mask set to obtain a first candidate encrypted image set; a restoring subunit, configured to restore an image in the first candidate encrypted image set using the pre-trained image restoration model, to obtain a second candidate encrypted image set; a first recognizing subunit, configured to recognize the image in the first candidate encrypted image set using the pre-trained encrypted image recognition model, to obtain a fourth recognition precision corresponding to each image in the first candidate encrypted image set; a second recognizing subunit, configured to recognize an image in the second candidate encrypted image set using the pre-trained encrypted image recognition model, to obtain a fifth recognition precision corresponding to each image in the second candidate encrypted image set; and a determining subunit, configured to determine the target encryption mask from the candidate encryption mask set based on the fourth recognition precision and the fifth recognition precision.

Further referring to FIG. 11, as an implementation of the method for recognizing an image, the present disclosure provides an embodiment of an apparatus for recognizing an image. The embodiment of the apparatus corresponds to the embodiment of the method shown in FIG. 8. The apparatus may be applied in various electronic devices.

As shown in FIG. 11, an apparatus 1100 for recognizing an image in this embodiment may include: a reading module 1101, a second superimposing module 1102 and a second recognizing module 1103. Here, the reading module 1101 is configured to read a predetermined target encryption mask. The second superimposing module 1102 is configured to superimpose a to-be-recognized image with the target encryption mask to obtain an encrypted to-be-recognized image. The second recognizing module 1103 is configured to input the encrypted to-be-recognized image into a pre-trained encrypted image recognition model to obtain an image recognition result.

In this embodiment, for specific processes of the reading module 1101, the second superimposing module 1102 and the second recognizing module 1103 in the apparatus 1100 for recognizing an image, and their technical effects, reference may be respectively made to relative descriptions of steps 801-803 in the corresponding embodiment of FIG. 8, and thus the specific processes and the technical effects will not be repeated here.

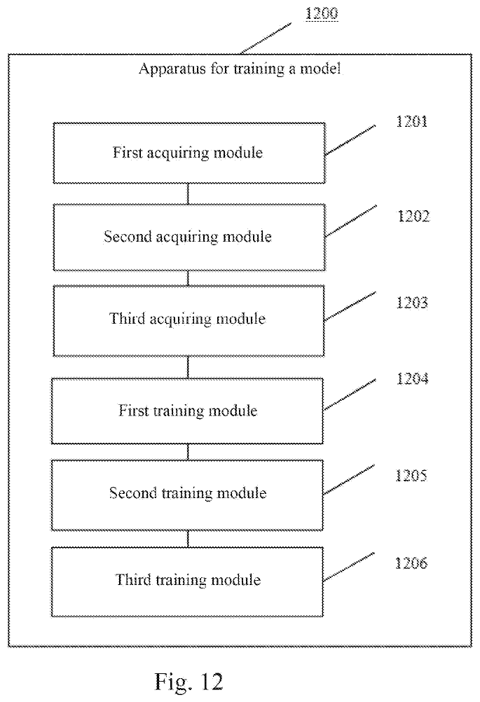

Further referring to FIG. 12, as an implementation of the method for training a model, the present disclosure provides an embodiment of an apparatus for training a model. The embodiment of the apparatus corresponds to the embodiment of the method shown in FIG. 9. The apparatus may be applied in various electronic devices.

As shown in FIG. 12, an apparatus 1200 for training a model in this embodiment may include: a first acquiring module 1201, a second acquiring module 1202, a third acquiring module 1203, a first training module 1204, a second training module 1205 and a third training module 1206. Here, the first acquiring module 1201 is configured to acquire a first image set and an encryption mask set, and determine the first image set as a first training sample. The second acquiring module 1202 is configured to perform random sampling on a mask in the encryption mask set, and superimpose an image in the first image set with a mask obtained through the sampling to obtain a second training sample. The third acquiring module 1203 is configured to acquire a second image set, and determine the second image set as a third training sample. The first training module 1204 is configured to train a first initial model based on the first training sample to obtain an original image recognition model. The second training module 1205 is configured to train, based on the second training sample, a second initial model using a given training parameter used to train the first initial model, to obtain an encrypted image recognition model. The third training module 1206 is configured to train a third initial model based on the third training sample, to obtain an image restoration model.

In this embodiment, for specific processes of the first acquiring module 1201, the second acquiring module 1202, the third acquiring module 1203, the first training module 1204, the second training module 1205 and the third training module 1206 in the apparatus 1200 for training a model, and their technical effects, reference may be respectively made to relative descriptions of steps 901-906 in the corresponding embodiment of FIG. 9, and thus the specific processes and the technical effects will not be repeated here.

According to an embodiment of the present disclosure, the present disclosure further provides an electronic device, a readable storage medium and a computer program product.

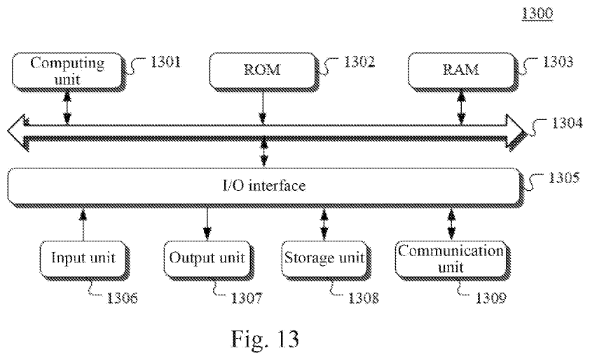

FIG. 13 is a schematic block diagram of an example electronic device 1300 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 13, the device 1300 includes a computing unit 1301, which may perform various appropriate actions and processing, based on a computer program stored in a read-only memory (ROM) 1302 or a computer program loaded from a storage unit 1308 into a random access memory (RAM) 1303. In the RAM 1303, various programs and data required for the operation of the device 1300 may also be stored. The computing unit 1301, the ROM 1302, and the RAM 1303 are connected to each other through a bus 1304. An input/output (I/O) interface 1305 is also connected to the bus 1304.

A plurality of components in the device 1300 are connected to the I/O interface 1305, including: an input unit 1306, for example, a keyboard and a mouse; an output unit 1307, for example, various types of displays and speakers; the storage unit 1308, for example, a disk and an optical disk; and a communication unit 1309, for example, a network card, a modem, or a wireless communication transceiver. The communication unit 1309 allows the device 1300 to exchange information/data with other devices over a computer network such as the Internet and/or various telecommunication networks.

The computing unit 1301 may be various general-purpose and/or dedicated processing components having processing and computing capabilities. Some examples of the computing unit 1301 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 1301 performs the various methods and processes described above, such as the method for determining an encryption mask, the method for recognizing an image, or the method for training a model. For example, in some embodiments, the method for determining an encryption mask, the method for recognizing an image, or the method for training a model may be implemented as a computer software program, which is tangibly included in a machine readable medium, such as the storage unit 1308. In some embodiments, part or all of the computer program may be loaded and/or installed on the device 1300 via the ROM 1302 and/or the communication unit 1309. When the computer program is loaded into the RAM 1303 and executed by the computing unit 1301, one or more steps of the method for determining an encryption mask, the method for recognizing an image, or the method for training a model described above may be performed. Alternatively, in other embodiments, the computing unit 1301 may be configured to perform the method for determining an encryption mask, the method for recognizing an image, or the method for training a model by any other appropriate means (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input apparatus and at least one output apparatus, and send the data and instructions to the storage system, the at least one input apparatus and the at least one output apparatus.

Program codes for implementing the method of the present disclosure may be compiled using any combination of one or more programming languages. The program codes may be provided to a processor or controller of a general purpose computer, a specific purpose computer, or other programmable apparatuses for data processing, such that the program codes, when executed by the processor or controller, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or server.

In the context of some embodiments of the present disclosure, a machine readable medium may be a tangible medium which may contain or store a program for use by, or used in combination with, an instruction execution system, apparatus or device. The machine readable medium may be a machine readable signal medium or a machine readable storage medium. The computer readable medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a server of a distributed system, or a server combined with a blockchain. The server may alternatively be a cloud server, or a smart cloud computing server with artificial intelligence technology, or a smart cloud host.

It should be understood that the various forms of processes shown above may be used to reorder, add, or delete steps. For example, the steps disclosed in some embodiments of the present disclosure may be executed in parallel, sequentially, or in different orders, as long as the desired results of the technical solutions mentioned in some embodiments of the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for determining an encryption mask, comprising:
acquiring a test image set and an encryption mask set;
superimposing an image in the test image set with a mask in the encryption mask set to obtain an encrypted image set;
recognizing an image in the encrypted image set using a pre-trained encrypted image recognition model and recognizing the image in the encrypted image set using a pre-trained original image recognition model to obtain a first recognition result; and
determining a target encryption mask from the encryption mask set based on the first recognition result.

2. The method according to claim 1, wherein the superimposing an image in the test image set with a mask in the encryption mask set to obtain an encrypted image set comprises:
dividing the encryption mask set into a plurality of encryption mask subsets based on an occlusion area of the mask in the encryption mask set;
superimposing the image in the test image set with a mask in the plurality of encryption mask subsets to obtain a plurality of encrypted image subsets; and
determining the plurality of encrypted image subsets as the encrypted image set.

3. The method according to claim 2, wherein the recognizing an image in the encrypted image set using a pre-trained encrypted image recognition model and recognizing the image in the encrypted image set using a pre-trained original image recognition model to obtain a first recognition result comprises:
recognizing the image in the encrypted image set using the pre-trained encrypted image recognition model, to obtain a first recognition precision corresponding to each encrypted image subset in the encrypted image set;
recognizing the image in the encrypted image set using the pre-trained original image recognition model, to obtain a second recognition precision corresponding to the each encrypted image subset in the encrypted image set; and
determining the first recognition precision and the second recognition precision as the first recognition result.

4. The method according to claim 3, wherein the determining a target encryption mask from the encryption mask set based on the first recognition result comprises:
determining a target encryption mask subset from the encryption mask set based on the first recognition precision and the second recognition precision, and determining an encrypted image subset corresponding to the target encryption mask subset as a target encrypted image subset;
recognizing an image in the target encrypted image subset using the pre-trained encrypted image recognition model to obtain a second recognition result; and
determining the target encryption mask from the target encryption mask subset based on the second recognition result.

5. The method according to claim 4, wherein the recognizing an image in the target encrypted image subset using the pre-trained encrypted image recognition model to obtain a second recognition result comprises:
recognizing the image in the target encrypted image subset using the pre-trained encrypted image recognition model, to obtain a third recognition precision corresponding to each image in the target encrypted image subset; and
determining the third recognition precision as the second recognition result.

6. The method according to claim 5, wherein the determining the target encryption mask from the target encryption mask subset based on the second recognition result comprises:
determining a candidate encryption mask set from the target encryption mask subset based on the third recognition precision; and
determining the target encryption mask from the candidate encryption mask set based on the pre-trained encrypted image recognition model and a pre-trained image restoration model.

7. The method according to claim 6, wherein the determining the target encryption mask from the candidate encryption mask set based on the pre-trained encrypted image recognition model and a pre-trained image restoration model comprises:
superimposing the image in the test image set with a mask in the candidate encryption mask set to obtain a first candidate encrypted image set;
restoring an image in the first candidate encrypted image set using the pre-trained image restoration model, to obtain a second candidate encrypted image set;
recognizing the image in the first candidate encrypted image set using the pre-trained encrypted image recognition model, to obtain a fourth recognition precision corresponding to each image in the first candidate encrypted image set;
recognizing an image in the second candidate encrypted image set using the pre-trained encrypted image recognition model, to obtain a fifth recognition precision corresponding to each image in the second candidate encrypted image set; and
determining the target encryption mask from the candidate encryption mask set based on the fourth recognition precision and the fifth recognition precision.

8. The method according to claim 1, wherein the method further comprises:
reading the predetermined target encryption mask;
superimposing a to-be-recognized image with the target encryption mask to obtain an encrypted to-be-recognized image; and
inputting the encrypted to-be-recognized image into the pre-trained encrypted image recognition model to obtain an image recognition result.

9. The method according to claim 1, wherein the method further comprises:
acquiring a first image set and the encryption mask set, and determining the first image set as a first training sample;
performing random sampling on a mask in the encryption mask set, and superimposing an image in the first image set with a mask obtained through the sampling to obtain a second training sample;
acquiring a second image set, and determining the second image set as a third training sample;
training a first initial model based on the first training sample to obtain the original image recognition model;
training, based on the second training sample, a second initial model using a given training parameter used to train the first initial model, to obtain the encrypted image recognition model; and
training a third initial model based on the third training sample, to obtain an image restoration model.

10. An electronic device, comprising:
at least one processor; and
a storage device, communicated with the at least one processor,
wherein the storage device stores instructions executable by the at least one processor, and the instructions, when executed by the at least one processor, cause the at least one processor to perform operations comprising:
acquiring a test image set and an encryption mask set;
superimposing an image in the test image set with a mask in the encryption mask set to obtain an encrypted image set;
recognizing an image in the encrypted image set using a pre-trained encrypted image recognition model and recognizing the image in the encrypted image set using a pre-trained original image recognition model to obtain a first recognition result; and
determining a target encryption mask from the encryption mask set based on the first recognition result.

11. The electronic device according to claim 10, wherein the superimposing an image in the test image set with a mask in the encryption mask set to obtain an encrypted image set comprises:
dividing the encryption mask set into a plurality of encryption mask subsets based on an occlusion area of the mask in the encryption mask set;
superimposing the image in the test image set with a mask in the plurality of encryption mask subsets to obtain a plurality of encrypted image subsets; and
determining the plurality of encrypted image subsets as the encrypted image set.

12. The electronic device according to claim 11, wherein the recognizing an image in the encrypted image set using a pre-trained encrypted image recognition model and recognizing the image in the encrypted image set using a pre-trained original image recognition model to obtain a first recognition result comprises:
recognizing the image in the encrypted image set using the pre-trained encrypted image recognition model, to obtain a first recognition precision corresponding to each encrypted image subset in the encrypted image set;
recognizing the image in the encrypted image set using the pre-trained original image recognition model, to obtain a second recognition precision corresponding to the each encrypted image subset in the encrypted image set; and
determining the first recognition precision and the second recognition precision as the first recognition result.

13. The electronic device according to claim 12, wherein the determining a target encryption mask from the encryption mask set based on the first recognition result comprises:
determining a target encryption mask subset from the encryption mask set based on the first recognition precision and the second recognition precision, and determining an encrypted image subset corresponding to the target encryption mask subset as a target encrypted image subset;
recognizing an image in the target encrypted image subset using the pre-trained encrypted image recognition model to obtain a second recognition result; and
determining the target encryption mask from the target encryption mask subset based on the second recognition result.

14. The electronic device according to claim 13, wherein the recognizing an image in the target encrypted image subset using the pre-trained encrypted image recognition model to obtain a second recognition result comprises:
recognizing the image in the target encrypted image subset using the pre-trained encrypted image recognition model, to obtain a third recognition precision corresponding to each image in the target encrypted image subset; and
determining the third recognition precision as the second recognition result.

15. The electronic device according to claim 14, wherein the determining the target encryption mask from the target encryption mask subset based on the second recognition result comprises:
determining a candidate encryption mask set from the target encryption mask subset based on the third recognition precision; and
determining the target encryption mask from the candidate encryption mask set based on the pre-trained encrypted image recognition model and a pre-trained image restoration model.

16. The electronic device according to claim 15, wherein the determining the target encryption mask from the candidate encryption mask set based on the pre-trained encrypted image recognition model and a pre-trained image restoration model comprises:
superimposing the image in the test image set with a mask in the candidate encryption mask set to obtain a first candidate encrypted image set;
restoring an image in the first candidate encrypted image set using the pre-trained image restoration model, to obtain a second candidate encrypted image set;
recognizing the image in the first candidate encrypted image set using the pre-trained encrypted image recognition model, to obtain a fourth recognition precision corresponding to each image in the first candidate encrypted image set;
recognizing an image in the second candidate encrypted image set using the pre-trained encrypted image recognition model, to obtain a fifth recognition precision corresponding to each image in the second candidate encrypted image set; and
determining the target encryption mask from the candidate encryption mask set based on the fourth recognition precision and the fifth recognition precision.

17. The electronic device according to claim 10, wherein the operations further comprise:
reading the predetermined target encryption mask;
superimposing a to-be-recognized image with the target encryption mask to obtain an encrypted to-be-recognized image; and
inputting the encrypted to-be-recognized image into the pre-trained encrypted image recognition model to obtain an image recognition result.

18. The electronic device according to claim 10, wherein the operations further comprise:
acquiring a first image set and the encryption mask set, and determining the first image set as a first training sample;
performing random sampling on a mask in the encryption mask set, and superimposing an image in the first image set with a mask obtained through the sampling to obtain a second training sample;
acquiring a second image set, and determining the second image set as a third training sample;
training a first initial model based on the first training sample to obtain the original image recognition model;
training, based on the second training sample, a second initial model using a given training parameter used to train the first initial model, to obtain the encrypted image recognition model; and
training a third initial model based on the third training sample, to obtain an image restoration model.

19. A non-transitory computer readable storage medium, storing computer instructions, wherein the computer instructions cause a computer to perform operations comprising:
acquiring a test image set and an encryption mask set;
superimposing an image in the test image set with a mask in the encryption mask set to obtain an encrypted image set;
recognizing an image in the encrypted image set using a pre-trained encrypted image recognition model and recognizing the image in the encrypted image set using a pre-trained original image recognition model to obtain a first recognition result; and
determining a target encryption mask from the encryption mask set based on the first recognition result.

20. The storage medium according to claim 19, wherein the superimposing an image in the test image set with a mask in the encryption mask set to obtain an encrypted image set comprises:
dividing the encryption mask set into a plurality of encryption mask subsets based on an occlusion area of the mask in the encryption mask set;
superimposing the image in the test image set with a mask in the plurality of encryption mask subsets to obtain a plurality of encrypted image subsets; and
determining the plurality of encrypted image subsets as the encrypted image set.
